(19) United States
(12) Patent Application Publication
(10) Pub. No.: US 2015/0054614 A1
(43) Pub. Date: Feb. 26, 2015

(54) FUSES

(71) Applicant: GE ENERGY POWER CONVERSION TECHNOLOGY LIMITED, Warwickshire, Warwickshire (GB)

(72) Inventors: Mark Warren Blewitt, Rugby (GB); Allan David Crane, Gwynedd (GB); Andrew Goldney, Crick (GB)

(73) Assignee: GE ENERGY P[OWER CONVERSION TECHNOLOGY LIMITED, Warwickshire, Warwickshire (GB)

(21) Appl. No.: 14/384,209

(22) PCT Filed: Feb. 15, 2013
(86) PCT No.: PCT/EP13/53135

§ 371 Date: Sep. 10, 2014

(30) Foreign Application Priority Data
Mar. 12, 2012 (EP) 12159063.2

(51) Int. Cl. H01H 85/50; H01H 85/40; H01H 85/00

(52) U.S. Cl. CPC H01H 85/50; H01H 85/0039; H01H 85/40; H01H 2085/209
USPC 337/277; 337/292; 337/283

(57) ABSTRACT

A fuse assembly for interrupting fault current in an external DC circuit. The fuse assembly includes 2n fusible conductor elements, where n is an integer, wherein the fusible conductor elements extend along, and are circumferentially around, a longitudinal axis of the fuse assembly. The fusible conductor elements are connected together in series to define fuse elements and the fusible conductor elements are orientated within the fuse assembly such that current flowing along each fusible conductor element is in the opposite direction to current flowing along the fusible conductor element or fusible conductor elements adjacent to it. The fuse assembly further includes a supply terminal connected to an end of the fuse element and connectible to a DC supply, and a load terminal connected to an opposite end of the first fuse element and connectible to an electrical load.

### TECHNICAL FIELD

Embodiments of the present invention relate to fuses, and in particular, to fuses that can be used to interrupt fault current in an external DC circuit.

### BACKGROUND ART

Fault-rated fuses that rupture and subsequently develop sufficient arc voltage in order to interrupt current flow in an external DC circuit are well known. It is also known that arc extinction in fuses is caused by the removal of heat from the arc by a number of cooling processes that are influenced by the nature of the material that surrounds the arc. These fuses and their underlying principles are described in ‘Electric Fuses’, A Wright & P G Newbery, 1982.

It is known to extend the length of an arc by various deflection and barrier methods, thereby increasing the arc voltage that is attainable within a particular size of fuse assembly. However, these methods are optimised for high power systems and are therefore associated with a degree of complexity that would be un-warranted in the case of protective devices for use at relatively low currents.

### SUMMARY OF THE INVENTION

In a first arrangement, the present invention provides a fuse assembly comprising: 2n fusible conductor elements, where n is an integer, the fusible conductor elements extending substantially along, and being circumferentially spaced around, a longitudinal axis of the fuse assembly, wherein the fusible conductor elements are connected together in series to define a fuse element, the fusible conductor elements being orientated within the fuse assembly such that current flowing along each fusible conductor element is in the opposite direction to current flowing along the fusible conductor element or fusible conductor elements adjacent to it (i.e. the fusible conductor elements experience a mutually repulsive force or, at the very least, do not experience a mutually attractive force). The fuse assembly further comprises: a supply terminal connected to an end of the fuse element and connectible to a DC supply; and a load terminal connected to an opposite end of the fuse element and connectible to an electrical load.

Such an arrangement is particularly suitable for use with a unipolar DC supply and the supply terminal can be connected to the positive (+ve) terminal of the DC supply and the load terminal can be connected to the positive terminal of the electrical load. The negative (−ve) terminal of the electrical load can be connected to the negative terminal of the DC supply. The series interconnection in sequence according to conventional current flow could therefore be: DC supply (+ve terminal)-[supply terminal-fuse element-load terminal]-electrical load (+ve terminal)-electrical load (−ve terminal)-DC supply (−ve terminal), where [ . . . ] indicates components of the fuse assembly.

In a second arrangement, the present invention provides a fuse assembly comprising: 2n fusible conductor elements, where n is an integer, the fusible conductor elements extending substantially along, and being circumferentially spaced around, a longitudinal axis of the fuse assembly, wherein a first fuse element is defined by n fusible conductor elements connected together in series and a second fuse element is defined by n fusible conductor elements connected in series, the fusible conductor elements being orientated within the fuse assembly such that current flowing along each fusible conductor element is in the opposite direction to current flowing along the fusible conductor element or fusible conductor elements adjacent to it. The fuse assembly further comprises: a first supply terminal connected to an end of the first fuse element and connectible to a DC supply; a first load terminal connected to an opposite end of the first fuse element and connectible to an electrical load; a second supply terminal connected to an end of the second fuse element and connectible to the DC supply; and a second load terminal connected to an opposite end of the second fuse element and connectable to the electrical load.

Such an arrangement is particularly suitable for use with a bipolar DC supply. The first supply terminal can be connected to the positive terminal of the DC supply, the first load terminal can be connected to the positive terminal of the electrical load, the second load terminal can be connected to the negative terminal of the electrical load, and the second supply terminal can be connected to the negative terminal of the DC supply. The series interconnection in sequence according to conventional current flow could therefore be: DC supply (+ve terminal)-[first supply terminal-first fuse element-first load terminal]-electrical load (+ve terminal)-electrical load (−ve terminal)-[second load terminal-second fuse element-second supply terminal]-DC supply (−ve terminal), where [ . . . ] indicates components of the fuse assembly.

The fusible conductor elements may carry the same DC current of either the same or opposite polarity depending on whether the fuse assembly is used with a unipolar or bipolar DC supply, respectively. However, in certain protective modes such an asymmetric ground fault the current in the fuse elements may not be equal. As long as the fuse element that experiences fault current includes an even number of series connected fusible conductor elements then the mutually repulsive force described below will apply to the fault-affected fusible conductor elements and to a lesser extent to the non fault-affected fusible conductor elements. In this case, a bipolar DC supply may be used that has a ‘stiffly’ grounded centre tap or a resistively grounded centre tap, having sufficiently low resistance to cause fault current to exceed the fuse rupturing current (i.e. the current at which the fusible conductor elements will rupture). It will be readily appreciated that it would be more conventional for the bipolar DC supply to have a ‘floating’ or high resistance centre tap in order to limit asymmetric fault currents.

The fusible conductor elements can be considered to be located at an apex of a polygonal array (e.g. for four elements at the apex of a square or rectangular array, for six elements at the apex of a hexagonal array, etc). The fusible conductor elements may be equally spaced apart, so that the mutually repulsive force experienced by each element is substantially equal. However, if a particular high voltage is present between adjacent terminals then an increased spacing may be employed to reduce the risk of flashover between the terminals.

The feature of an embodiment of the present invention having mutually repulsive forces that are symmetrical or equal is not a requirement for all of the benefits and advantages of the fuse assembly construction to be realised. The above-described situation where the fuse assembly experiences an asymmetric fault current is an example. Further, embodiments of the present invention provide that the fusible conductor elements, and the arcs that are established between the terminals when the fuse assembly interrupts a fault current, are not mutually attracted.

The fusible conductor elements will typically be circular wire elements but foil elements can be used. The fusible conductor elements can be substantially straight or have a serpentine or helical form to increase their overall length. In the case of a serpentine or helical fusible conductor element then its neutral axis may be substantially parallel to the longitudinal axis of the fuse assembly.

The fuse assemblies of embodiments of the present invention can be used to protect high voltage direct current (HVDC) circuits that normally operate at low current levels (e.g. <5 A) from sustained thermal overloads and high fault currents (e.g. >20 A). In order to interrupt the fault current, the fuse assembly can develop an arc voltage that is substantially in excess of the supply voltage, which might typically be >100 kV.

Each fuse element can be immersed in a liquid dielectric, such as a proprietary transformer insulating fluid like MIDEL 7131, for example. The liquid dielectric improves cooling and the generation of arc voltages because the arc characteristic within a liquid dielectric has a negative resistance region at currents below a particular threshold. It will be readily appreciated that the combination of the pre-arcing resistance of the fusible conductor elements and the series-connected minimum prospective fault resistance must be sufficiently large to limit the prospective fault current to a level that ensures effective operation of the fuse assemblies by (i) being in the negative resistance region of the arc characteristic, and (ii) being in a region of the arc characteristic where sufficiently high arc voltage per metre of fuse element length is developed. A long fuse element implies a long arc and hence the desired high arc voltage. A fuse element length of 2 metres might be typical and this would normally require a total fuse assembly length of 2.5 metres or more. In the fuse assemblies of embodiments of the present invention, the individual series-connected fusible conductor elements are physically arranged within the fuse assembly to define a ‘folded’ fuse element that significantly reduces the length of the fuse assembly.

Folding the fuse element and orientating the individual fusible conductor elements within the fuse assemblies such that current flowing along each fusible conductor element is in the opposite direction to current flowing along the fusible conductor element or fusible conductor elements adjacent to it means that the fusible conductor elements experience a mutually repulsive force. In the simple case where the fuse element includes just two fusible conductor elements (i.e. n=1) then they can be connected together in series to define a substantially U-shaped fuse element or, in the case where the fuse assembly is used with a bipolar DC supply, with each fusible conductor element carrying the same DC current but with opposite polarity, then each individual fusible conductor element can be arranged within the fuse assembly such that the direction of current flow along each between the respective load and supply terminals along each fuse element is opposite. The fusible conductor elements therefore experience a mutually repulsive force arising from the electromagnetic interaction between them. This mutually repulsive force is also experienced as the fusible conductor elements initially start to melt (e.g. during a pre-arcing stage) and when fault current is no longer able to flow through the fusible conductor elements and an arc is established (early and fully-established arcing stages). It will therefore be readily appreciated that the mutually repulsive force reduces the risk of flashover between the individual fusible conductive elements by maintaining their physical separation, irrespective of whether insulating barriers are placed between parallel-extending elements. This means that the fusible conductive elements can be relatively closely spaced which further reduces the physical size of the fuse assembly. In the case where n=1 with a bipolar DC supply then, in the case of an asymmetric fault current, the mutually repulsive force will not apply to non fault-affected fusible conductor elements.

If the fuse assembly is to provide proper protection against asymmetric fault current then each fuse element may include an even number of fusible conductor elements (i.e. n=2, 4, 6 etc.). In an embodiment, the fuse assemblies include four fusible conductor elements (i.e. n=2) arranged in a square or rectangular array with either one or two fuse elements. In the case where the fuse assembly includes two fuse elements then each fuse element is substantially U-shaped (or ‘folded’ and is connected between a pair of external terminals. The DC current flowing through each fuse element has opposite polarity.

When each fuse element melts and an arc is established then the intense heat causes a chemical breakdown of the surrounding liquid dielectric and a gas bubble that envelops the arc is rapidly formed. In the case of transformer insulating fluids such as MIDEL 7131 the gas bubble may comprise about 80% hydrogen, the pressure of which rises rapidly, experiencing turbulence and attaining a high thermal conductivity in the process. This high thermal conductivity and the convective cooling associated with turbulence extracts heat from the arc, deionises the arc and causes it to be extinguished. The energy that must be dissipated by the arc during the extinction process is dominated by that stored in the inductance of the overall DC circuit that includes the DC source, the fuse assembly and the faulty electrical load because the extinction process is extremely rapid once arcing has been initiated. Current fall time may be less than 50 μs, and therefore, little energy is dissipated in the resistance of the DC circuit. This dissipated energy has a direct influence on the volume of liquid dielectric that decomposes and hence on the volume and pressure of the resulting gas bubble. The fuse assemblies can therefore include means for moderating the gas pressure and consequent shock wave in order to maintain the structural integrity of the fuse assemblies. In one arrangement, a gas-filled collapsible accumulator for dissipating the shock wave can be positioned close to and along substantially the entire length of the fuse element. The pressure of the gas bubble causes the liquid dielectric to be displaced and the associated flow of liquid is into the space that was formerly occupied by the accumulator, thereby causing the accumulator pressure to increase and for it to collapse. The accumulator may be designed to allow some degree of control of the gas pressure. Any suitable accumulator design can be used and the accumulators can be properly positioned within the fuse assembly (and more particularly within a duct) by any suitable fixing or positioning means.

There is no requirement to have solid insulation barriers between the fusible conductor elements because of the mutually repulsive force. However, such barriers can be provided in order to form a convenient containment in the form of ducts or conduits that can be filled with the liquid dielectric. Each fusible conductor element and an associated accumulator can be located within its own duct. Internal terminals can facilitate a series connection between the individual fusible conductor elements within the fuse assembly and can extend through the solid insulation barriers (e.g. duct walls).

In one arrangement, the ducts or conduits are fixed or secured together in parallel to form a duct assembly and are sealed by end plates on which the external load and supply terminals are mounted, e.g. by terminal bushings. Small openings are provided in the end plates so that liquid dielectric can be supplied to, and removed from, the ducts. The ducts may be orientated to be substantially horizontal in use but substantially vertically orientated ducts can also be used. The duct assembly can be surrounded by banding or the like to provide a structural reinforcement, which may be electrically insulating.

The fusible conductor elements can be connected to the various terminals by compression contacts that incorporate strain reliefs to accommodate differential thermal expansion and thermal cycling.

Each fusible conductor element can have an associated electrostatic shield to suppress surface discharges and the potential formation of conductive streamers within the dielectric liquid. Each electrostatic shield can be formed from a metallised film, e.g. a metallised polypropylene film. The metallisation may be electrically connected to the terminals at the ends of the corresponding fusible conductor element by any convenient means. The shield metallisation is, therefore, connected electrically in parallel with the corresponding fusible conductor element.

Each electrostatic shield can be curved around the corresponding fusible conductor element. For example, each electrostatic shield can be in the form of a curved member with a radius about the longitudinal axis of the corresponding fusible conductor element. Each electrostatic shield can be held in position within the associated duct by its end terminations so that the profile of the shield is maintained along substantially its entire length. When the fuse assembly is immersed in a liquid dielectric then the radius r can be chosen to minimise the electric field enhancement factor in the liquid dielectric between the shields.

An embodiment of the present invention further provides a fuse assembly comprising: a fuse element defined by at least one fusible conductor element; a first terminal connected to an end of the fuse element; a second terminal connected to an opposite end of the fuse element; and an electrostatic shield positioned adjacent each fusible conductor element.

Further features of embodiments of the fuse assembly can be as described herein.

### BRIEF DESCRIPTION OF THE DRAWINGS

Other object feature and advantages of the present invention will become evident from the following description of the embodiments of the invention taken in conjunction with the following drawings, wherein:

FIG. 1 is an end cross section view of a fuse assembly (where n=2) according to an embodiment of the present invention;

FIG. 2 is a side cross section view of the fuse assembly of FIG. 1;

FIG. 3A is a schematic drawing showing a fuse assembly (where n=1) connected to a unipolar DC supply according to an embodiment of the invention;

FIG. 3B is a schematic drawing showing a fuse assembly (where n=2) connected to a unipolar DC supply according to an embodiment of the invention;

FIG. 3C is a schematic drawing showing a fuse assembly (where n=2) connected to a bipolar DC supply according to an embodiment of the invention;

FIG. 4 is a drawing showing the forces acting on the fusible conductor elements of a fuse assembly (where n=2) according to an embodiment of the invention;

FIG. 5 shows a first fixing arrangement for fixing the end plates of the fuse assembly of FIG. 1;

FIG. 6 shows a second fixing arrangement for fixing the end plates of the fuse assembly of FIG. 1;

FIG. 7 shows a third fixing arrangement for fixing the end plates of the fuse assembly of FIG. 1;

FIG. 8 shows a side cross section view of an alternative arrangement for a fuse assembly according to an embodiment of the present invention where each accumulator extends through the end plate;

FIG. 9 shows an end cross section view of an alternative arrangement for a fuse assembly according to an embodiment of the present invention in which each accumulator is in the form of a substantially flat elastomeric sheet or diaphragm; and

FIG. 10 shows end and side cross section views of an alternative arrangement for a fuse assembly according to an embodiment of the present invention that incorporates electrostatic shields.

### DETAILED DESCRIPTION

Throughout the following description, like components have been given the same reference numeral.

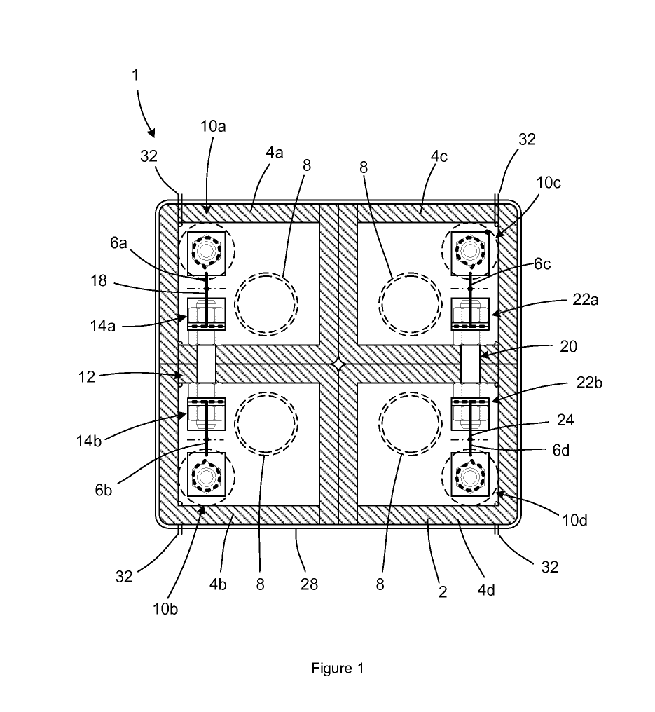

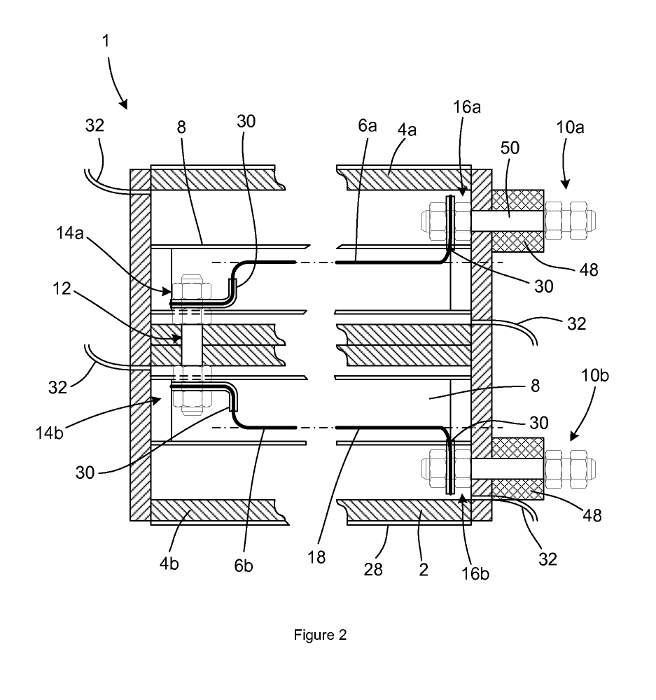

A fuse assembly 1 is shown in FIGS. 1 and 2 and includes a duct assembly 2 or housing with four ducts 4a, 4b, 4c, 4d in a 2×2 array. Each duct contains a fusible conductor element 6 (or fuse wire elements of circular cross section) and an accumulator 8 immersed in a liquid dielectric such as MIDEL 7131. More particularly, the interior of each duct 4a . . . 4d is filled with the liquid dielectric, such that the fusible conductor elements 6 and the accumulators 8 operate in a dielectric environment. The fusible conductor elements 6 extend substantially parallel to the longitudinal axis of the duct assembly 2. The fuse assembly 1, therefore, includes four fusible conductor elements 6a, 6b, 6c, 6d (i.e. n=2).

A first external terminal 10a is located at a first end of the first duct 4a. A second external terminal 10b is located at a first end of the second duct 4b. A first internal terminal 12 is located at a second end of the first and second ducts 4a, 4b and is located within the duct assembly 2. The first internal terminal 12 extends through the adjacent walls of the first and second ducts 4a, 4b so that part 14a of the first internal terminal is located within the first duct 4a and part 14b is located within the second duct 4b.

A first end of the first fusible conductor element 6a is connected to the first external terminal 10a within the duct assembly (i.e. to a part 16a of the first external terminal that is located within the first duct 4a). A second end of the first fusible conductor element 6a is connected to the part 14a of the first internal terminal 12 that is located within the first duct 4a. The first fusible conductor element 6a therefore extends along the first duct 4a between the first external terminal 10a and the first internal terminal 12. A first end of the second fusible conductor element 6b is connected to the second external terminal 10b within the duct assembly (i.e. to a part 16b of the second external terminal that is located within the second duct 4b). A second end of the second fusible conductor element 6b is connected to the part 14b of the first internal terminal 12 that is located within the second duct 6b. The second fusible conductor element 6b therefore extends along the second duct 4b between the second external terminal 10b and the first internal terminal 12. The first and second fusible conductor elements 6a, 6b are connected together in series by means of the first internal terminal 12 to define a first substantially U-shaped fuse element 18.

A third external terminal 10c is located at a first end of the third duct 4c. A fourth external terminal 10d is located at a first end of the fourth duct 4c. A second internal terminal 20 is located at a second end of the third and fourth ducts 4c, 4d and is located within the duct assembly 2. The second internal terminal 20 extends through the adjacent walls of the third and fourth ducts 4d, 4c so that part 22a of the second internal terminal is located within the third duct 4c and part 22b is located within the fourth duct 4d.

A first end of the third fusible conductor element 6c is connected to the third external terminal 10c within the duct assembly (i.e. to a part of the third external terminal that is located within the third duct). A second end of the third fusible conductor element is connected to the part 22a of the second internal terminal 20 that is located within the third duct 4c. The third fusible conductor element 6c, therefore, extends along the third duct 4c between the third external terminal 10c and the second internal terminal 20. A first end of the fourth fusible conductor element 6d is connected to the fourth external terminal 10d within the duct assembly (i.e. to a part of the fourth external terminal that is located within the fourth duct 4d). A second end of the fourth fusible conductor element 6d is connected to the part 22b of the second internal terminal 20 that is located within the fourth duct 4d. The fourth fusible conductor element 6d, therefore, extends along the fourth duct 4d between the fourth external terminal 10d and the second internal terminal 20. The third and fourth fusible conductor elements 6c, 6d are connected together in series by means of the second internal terminal 20 to define a second substantially U-shaped fuse element 24.

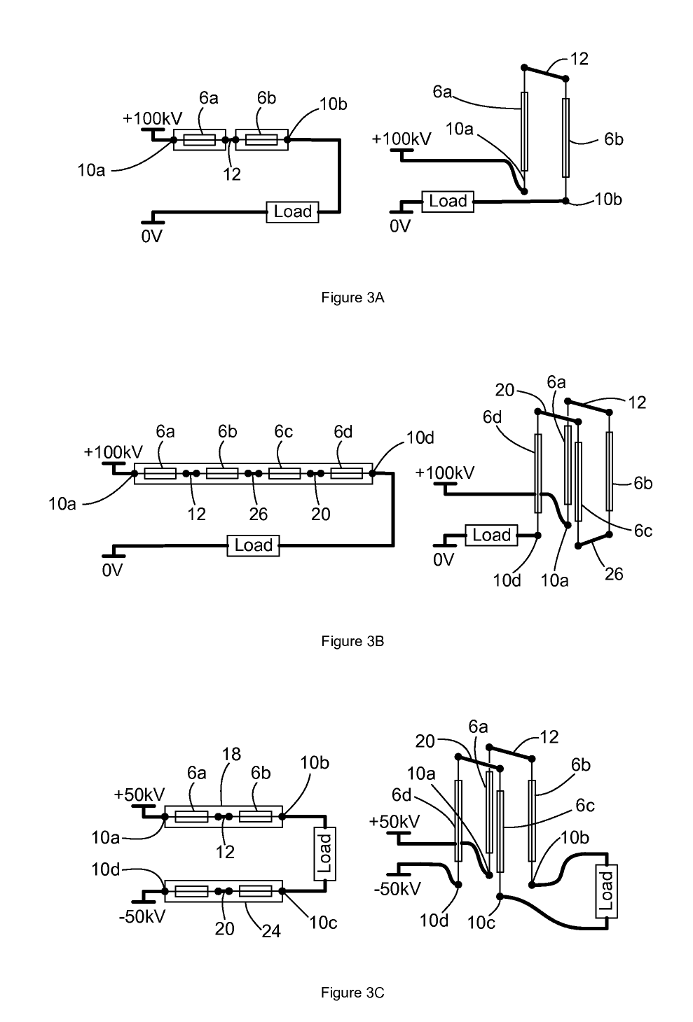

It will be readily appreciated that in its most basic form, the fuse assembly 1 might consist of just two fusible conductor elements (i.e. n=1). For example, a first fusible conductor element could be connected between first and second external terminals and a second fusible conductor element could be connected between third and fourth external terminals with the various external terminals being connected to an external DC circuit with a bipolar HVDC supply in a similar manner to that shown in FIG. 3C. In an alternative arrangement, just the first substantially U-shaped fuse element 18 consisting of the series-connected first and second fusible conductor elements 6a, 6b could be used with the first and second external terminals 10a, 10b being connected to an external DC circuit with a unipolar HVDC supply, as shown in FIG. 3A. More particularly, the first external terminal 10a could be a supply terminal connected to the positive terminal of the unipolar HVDC supply and the second external terminal 10b could be a load terminal connected to the positive terminal of an electrical load.

In the case of a unipolar HVDC supply then it will also be readily appreciated that the second and third external terminals 10b, 10c could, in practice, be replaced by a third internal terminal 26 (shown schematically in FIG. 3B where n=2) within the duct assembly (i.e. extending through the adjacent walls of the second and third ducts 4b, 4c so that part of the third internal terminal is located within the second duct and part is located within the third duct) so that the second and third fusible conductor elements 6b, 6c can be connected together in series to define a single fuse element that extends between the first and fourth external terminals 10a, 10d. In this case the first and fourth external terminals 10a, 10d could be connected to the positive (+ve) terminal of the unipolar HVDC supply and the positive terminal of the electrical load, respectively, of an external DC circuit, as shown in FIG. 3B.

The fuse assembly shown in FIGS. 1 and 2 is intended to be used with an external DC circuit that includes a bipolar HVDC supply as shown schematically in FIG. 3C where n=2. More particularly, the first external terminal 10a could be a supply terminal connected to the positive (+ve) terminal of the bipolar HVDC supply, the second external terminal 10b could be a load terminal connected to the positive terminal of an electrical load, the third external terminal 10c could be a load terminal connected to the negative (−ve) terminal of the electrical load, and the fourth external terminal 10d could be a supply terminal connected to the negative terminal of the HVDC supply. The fuse assembly shown in FIG. 3C is the most basic form for proper protection against an asymmetric fault current with a bipolar DC supply.

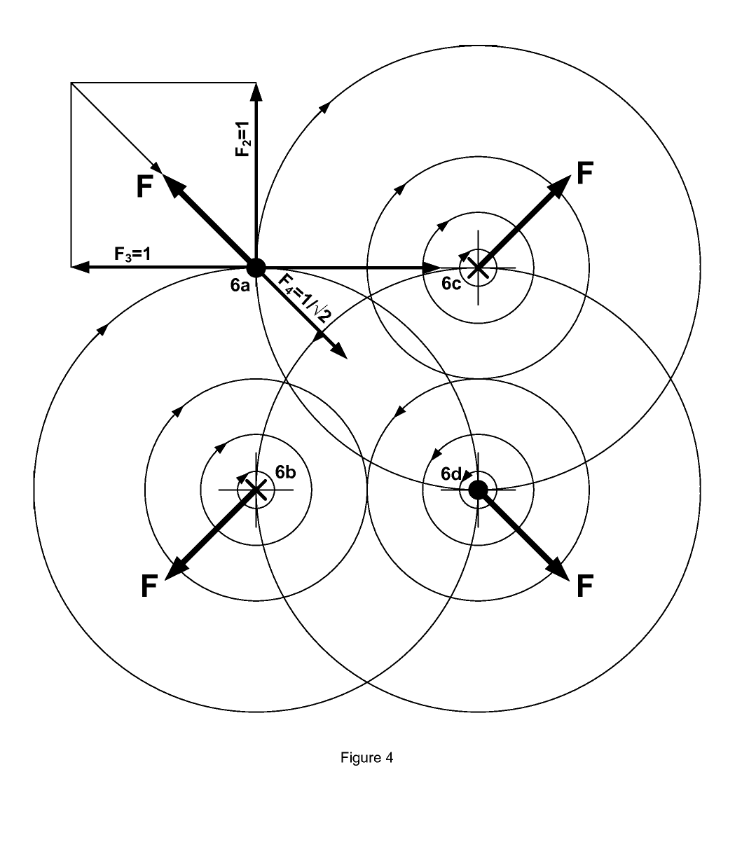

When a load or fault current flows through the fuse assembly 1, all of the fusible conductor elements 6a . . . 6d are connected in series and therefore carry the same current. In the arrangement shown in FIG. 3C, the current flowing through the first and second fusible conductor elements 6a, 6b (i.e. first substantially U-shaped fuse element 18) has a positive polarity and the current flowing through the third and fourth fusible conductor elements 6c, 6d (i.e. the second substantially U-shaped fuse element 24) has a negative polarity. The fusible conductor elements 6a . . . 6d also experience electromagnetic mutual coupling. It is well known that parallel conductors with current flowing in opposite directions experience a mutually repulsive force. The magnetic flux density attributable to and surrounding each fusible conductor element 6a . . . 6d varies inversely with the radius from the element and the associated repulsive forces are inversely proportional to the separation and proportional to the current. The vector relationships of flux linkage and resultant relative magnitudes of forces on four fusible conductor elements 6a . . . 6d in a square array are shown in FIG. 4 where each element carries the same magnitude of current. The opposing current polarities carried by the fusible conductor elements 6a . . . 6d are indicated by the industry standard notations • and x. In the fuse assembly shown in FIGS. 1 and 2, current flows along the first fusible conductor element 6a from the first external terminal 10a to the first internal terminal 12 (i.e. into the plane of the paper of from right to left as shown in FIG. 2) and along the second fusible conductor element 6b from the first internal terminal 12 to the second external terminal 10b (i.e. out of the plane of the paper or from left to right as shown in FIG. 2). Similarly, current flows along the third fusible conductor element 6c from the third external terminal 10c to the second internal terminal 20 (into the plane of the paper) and along the fourth fusible conductor element 6d from the second internal terminal 20 to the fourth external terminal 10d (e.g. out of the plane of the paper). It can therefore be seen that the fusible conductor elements 6a . . . 6d are orientated within the duct assembly 2 such that current flowing along each fusible conductor element is in the opposite direction to current flowing along the fusible conductor elements adjacent to it.

The force acting on the first fusible conductor element 6a attributable to magnetic flux from the second fusible conductor element 6b is annotated F₂ and is mutually repulsive. The force acting on the first fusible conductor element 6a attributable to magnetic flux from the third fusible conductor element 6c is annotated F₃ and is mutually repulsive. The force acting on the first fusible conductor element 6a attributable to magnetic flux from the fourth fusible conductor element 6b is annotated F₄ and is mutually attractive. The vector summated force acting on the first fusible conductor element 6a is annotated F. By symmetry, the vector summated forces acting on the second, third and fourth fusible conductor elements 6b . . . 6d have equal magnitudes and are also annotated F. All four fusible conductor elements 6a . . . 6d experience a mutually repulsive force and it can be shown that this mutual repulsion is similarly effective when the four fusible conductor elements are disposed in a rectangular array as opposed to the square array shown in FIG. 4. The advantages of this mutual repulsive force are described in more detail below. In the case of an asymmetric fault, then the vector relationship will be different. More particularly, the currents in the two fault-affected fusible conductor elements dominate over those in the two non fault-affected fusible conductor elements which actually decrease as the load experiences only one half of its normal supply voltage.

Each duct 4a . . . 4d is constructed from a structural and electrically insulating composite material that is compatible with the liquid dielectric. Glass reinforced epoxy angle profiles are shown and pairs are bonded together using epoxy in order to form each tubular duct. Alternatively, a one piece box profile may be employed. The ducts 4a . . . 4d are epoxy bonded together. The ducts 4a . . . 4d are also bonded to a tension-wound glass fibre reinforced epoxy banding system 28 that is used to ensure structural integrity under conditions when the ducts are exposed to a higher liquid pressure than their surroundings. The banding system 28 may be wound over a packing piece (not shown) in order to give the band the curvature that is necessary for its tensile load to be translated into radial (anti-bursting) force upon the exterior walls of the ducts. In other cases, the flat walls of the ducts 4a . . . 4d may have sufficient rigidity to withstand the bending moments associated with internal pressure without buckling and the banding is employed in order to rigidly compress the mating edges of the individual duct components that form the complete duct assembly 2.

With reference to FIG. 2, it can be seen that the fusible conductor elements 6a . . . 6d are substantially parallel to the longitudinal axis of the fuse assembly 2 for substantially their entire length. Their terminated ends are secured to threaded parts of the various external terminals 10a . . . 10d and internal terminals 12, 20 with mechanical strain reliefs 30. The fusible conductor elements 6a . . . 6d are compressed between mating parts of the strain reliefs 30. The extremities of the strain reliefs 30 have a radius so as to avoid point contact and stress concentration where the fusible conductor element enters the strain relief. The strain reliefs 30 are disposed so both ends of each fusible conductor element 6a . . . 6d transit into the terminals via a right angle bend of sufficient radius to diffuse the effects of shock during handling and in service, and differential thermal expansion during changes in fuse element and duct temperatures.

One or more intermediate supports (not shown) can be used to support the fusible conductor elements 6a . . . 6d between their terminated ends. Any convenient intermediate support means may be employed, and may be arranged such that the fusible conductor element 6a . . . 6d and associated supports are separated to substantially prevent the supports from thermally decomposing and forming a low electrical resistivity path that diverts current from the arc.

Although a number of wire materials may be used for the fusible conductor elements 6a . . . 6d, the wire material may be austenitic stainless steel grade 304 or other alloy with a significant positive thermal coefficient of resistivity. This particular wire has a high electrical resistivity, a high positive temperature coefficient of resistance, adequate mechanical strength and fatigue resistance, has been shown not to exert a significant catalytic effect upon the thermal decomposition of the liquid dielectric, and has been shown to be resistant to corrosion when immersed in the liquid dielectric at the maximum continuous working temperatures. The maximum continuous working temperature of the wire may be about 150° C. The maximum continuous working temperature of the liquid dielectric may be about 70° C.

The resistance of the fusible conductor elements 6a . . . 6d is associated with dissipation and since a physically long (but ‘folded’) fuse element is employed the dissipation is significant and affects the efficiency of equipment in the external DC circuit. Since the fuse assembly 1 of some embodiments of the present invention may be used with equipment having a relatively low power rating relative to the HVDC supply voltage and, more particularly, with auxiliary power supplies for power conversion equipment having a high power rating, e.g. typically >3 MW, the effect on total power conversion system efficiency is disproportionately low and is completely acceptable, particularly when the simplicity of the fuse assembly 1 is taken into account. The pre-arcing resistance of the fusible conductor elements 6a . . . 6d reduces the pre-arcing fault current and, consequently reduces the inductive energy that is dissipated during arcing. A reduction in pre-arcing current and arcing energy significantly benefits the operation of the fuse assembly 1.

The resistance of the fusible conductor elements 6a . . . 6d can be further increased by increasing their length by sequentially bending each fusible conductor element into a serpentine or helical form. For the purposes of the mutually repulsive force described above, such a fusible conductor element having a serpentine or helical form would still be considered to extend substantially along the longitudinal axis of the fuse assembly 1. More particularly, the neutral axis of each serpentine or helical fusible conductor element would be substantially parallel to the longitudinal axis of the fuse assembly 1. As the end of the pre-arcing phase is approached the increased resistance of the fusible conductor elements would limit fault current. Similarly, in the early stages of the arcing phase, the increased arc voltage of the serpentine or helical form arc would limit fault current. It is recognised that the arc will rapidly re-align to follow the shortest path between the terminals so arc length will shorten as re-alignment progresses. In the case of a helical form, then each fusible conductor element could be wound around, or substantially surround, its associated accumulator. However, the arcing should not result in the associated accumulator forming a low resistance electrical path between the terminals of the particular fusible conductor element.

The prospective fault current may be further reduced by connecting the fuse assembly 1 in series with at least one resistor, which may immersed in the liquid dielectric.

In use, the longitudinal axis of the fuse assembly 1 is substantially horizontal. The duct assembly 2 is completely immersed in liquid dielectric and means must be provided to ensure that each duct 4a . . . 4d is substantially filled with liquid dielectric whilst air is substantially displaced, i.e. the assembly must be self-bleeding. Liquid dielectric is, therefore, supplied into and out of the ducts 4a . . . 4c through pipes 32 that can have pumped forced circulation or convection circulation. If the fuse assembly 1 is not mounted in use with its longitudinal axis substantially horizontal, then additional outlets for the liquid dielectric can be added to assist the self-bleeding process.

The fusible conductor elements 6a . . . 6d are inherently subject to resistive heating in use and undergo local convection cooling since gravity is perpendicular to the longitudinal axis of each element when its longitudinal axis is substantially horizontal. Consequently, the temperature rise of the fusible conductor elements 6a . . . 6d, relative to the surrounding liquid dielectric is substantially uniform and is limited, whilst the surrounding liquid dielectric itself is subject to a temperature rise relative to the surrounding duct and thereafter to the liquid dielectric that surrounds the duct—the fuse assembly 1 may be placed in a tank or housing (not shown) that is filled with liquid dielectric. Natural convection over the external surface of the ducts 4a . . . 4d and through the piped inlets and outlets 32 may suffice to limit and render uniform the temperature rise of the liquid dielectric within the duct. If the fuse assembly 1 is immersed in a tank or housing that serves other equipment that is force circulated, then the flow through the ducts 4a . . . 4d may be derived from that force circulated system.

The inlet and outlet pipes 32 are of sufficiently small bore to prevent significant or uncontrolled outflow of liquid dielectric and its gaseous decomposition by-products as a result of the gas pressure that is developed during arcing. Whilst the respective distances between the terminals within each duct 4a . . . 4d are inherently sufficient to withstand the applied voltage after arc extinction when polluted by the by-products of arcing, the respective clearance (line of sight) and creepage (tracking) distances between the exposed metallic surfaces of the external terminals 10a . . . 10d at the end of the duct assembly 2 might become insufficient to avoid flashover, if the surrounding liquid dielectric becomes similarly polluted. More particularly, any outflow that results from arcing may contain ionised or resistive or conductive components that are entrained in the flow and the consequent risk of flashover at the ends of the duct assembly 2 is eliminated by segregated routing of the pipes. Means are also provided to filter or sediment or otherwise separate these by-products from the bulk of the liquid dielectric when the fuse assembly 1 is immersed in a tank or housing that serves other equipment, or when other equipment shares a common liquid dielectric reservoir.

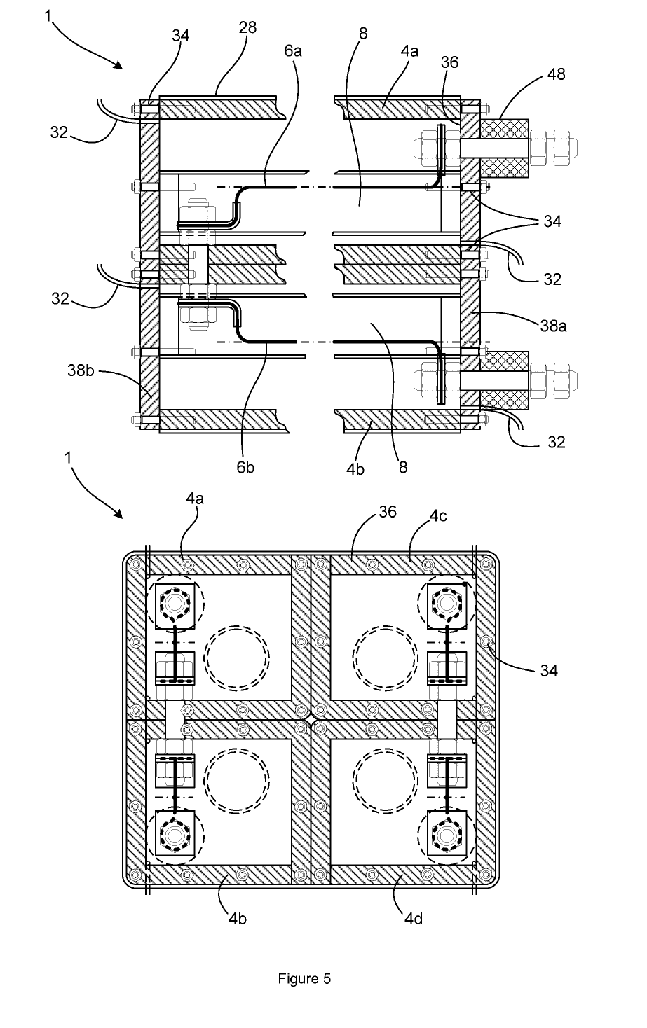

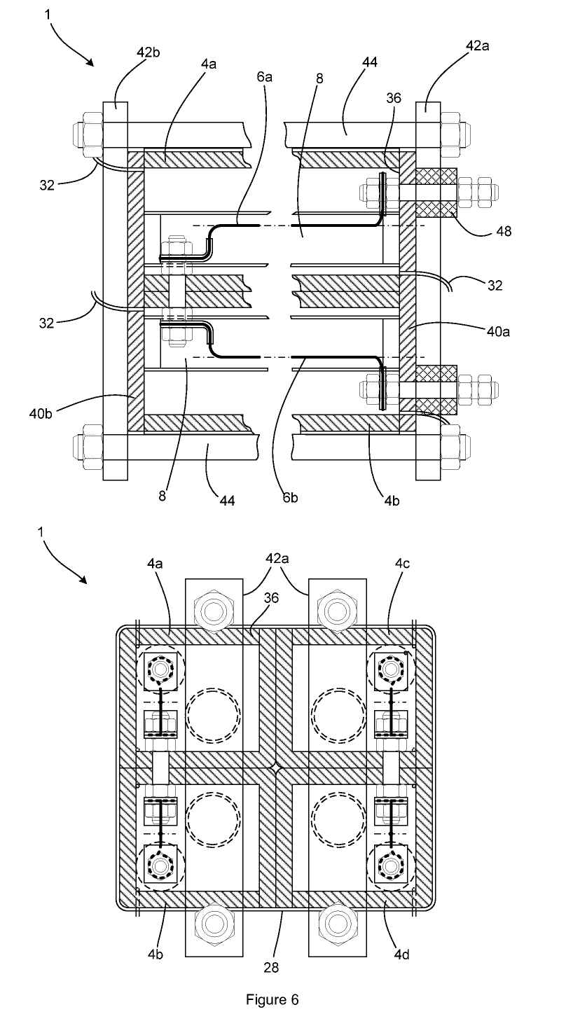

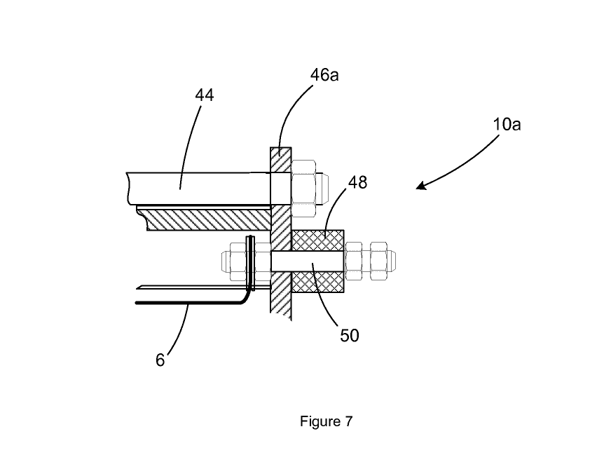

The end plates of the ducts 4a . . . 4d may be removable in order to permit the connection of the fusible conductor elements 6a . . . 6d to their respective terminals. The end plates are also sealed to the ends of the ducts 4a . . . 4c in a pressure-tight manner. Any suitable and convenient fixing arrangement can be used to secure the end plates to the ends of the ducts 4a . . . 4d and provide the necessary structural integrity as long as the electrical insulation between the terminals 10a . . . 10d is not compromised. Three examples of suitable fixing arrangements are shown in FIGS. 5 to 7. A first fixing arrangement shown in FIG. 5 uses any suitable number and size of threaded studs 34 that are screwed into the end faces 36 of the ducts 4a . . . 4d. The projecting ends of the threaded studs 34 are received in correspondingly aligned openings provided in the end plates 38a, 38b and suitable nuts and washers are used to secure the end plates to the ducts 4a . . . 4d and provide a pressure-tight seal. In a second fixing arrangement, shown in FIG. 6, the end plates 40a, 40b are compressed onto the end faces 36 of the ducts 4a . . . 4d by cross members 42a, 42b that are compressed by electrically insulating support rods 44 positioned outside the duct assembly 2. The support rods 44 are secured to the cross members 42a, 42b using suitable nuts and washers. A third fixing arrangement, shown in FIG. 7, may be adapted from the second fixing arrangement where the end plates (only one end plate 46a being shown) are sized so that the support rods 44 may be secured directly to the end plates, thereby dispensing with the cross members. Whatever fixing arrangement is used, additional sealing means such as o-ring seals (not shown) or non-permanent sealant (not shown) can be used to fill small spaces that may exist between surface irregularities of the ducts and the end plates. The terminal bushings 48 and the end plates and their fixings may be adapted to achieve the specified pressure-tight structural and insulation integrity.

The end plate with the external terminals 10a . . . 10d includes four bushings 48 whose dimensions and form are suitable for the designed working voltage. As shown, a circular cross section bushing 48 of glass re-enforced epoxy or other suitable composite material can be epoxy bonded to the end plate whilst this bonded interface is additionally compressed by appropriately tensioning the terminal stud that passes through the bushing and the end plate. The surface of the terminal stud 50 (FIG. 7) within and in contact with the bushing 48 can be dimensioned, profiled or otherwise adapted and epoxy bonded to reduce the risk of accidental rotation of the stud and to prevent uncontrolled leakage of the liquid dielectric and gas from within the duct. The outside of the bushings 48 can incorporate shedding.

As described above, the duct assembly 2 is capable of withstanding a particular internal pressure whilst outflow of liquid dielectric and gas is controlled by the inlet and outlet pipes 32. This particular internal pressure must not be exceeded and the necessary moderation of internal pressure can be performed by the collapsible gas filled accumulators 8a, 8b, 8c, 8d that are located within the ducts 4a . . . 4d.

As installed, and during normal working conditions of the fuse assembly 1, the gas filled accumulators 8a . . . 8d are internally pressurised and, in the arrangement shown in FIG. 1, have a cylindrical cross section in the absence of any external liquid dielectric pressurisation. Each accumulator 8a . . . 8d comprises an elastomeric tube that is either shrunk or bonded or compressed (compression rings or other devices not shown) on to two end plugs whilst at normal atmospheric pressure, thereby creating a gas tight sub-assembly whose internal pressure is thereafter affected by the temperature and pressure of the surrounding liquid dielectric. The flexibility of the elastomeric tube is such that its internal pressure is substantially equal to that of the surrounding liquid dielectric. The end plugs have internal threads that accommodate stud fixings. The accumulators 8a . . . 8d are secured to the end plates in a manner that prevents leakage of the liquid dielectric for the reasons previously specified above.

When the fusible conductor elements 6a . . . 6d melt and arcs are established then the intense heat causes a chemical breakdown of the surrounding liquid dielectric and a gas bubble that envelops the arc is rapidly formed. An understanding of the relationship between the volume and pressure of the gas bubble and the energy dissipated in the arc allows the volume of the installed accumulators 8a . . . 8d to be defined so as to moderate the peak pressure that is present within the ducts 4a . . . 4d immediately after arcing such that the pressure-tight structural integrity of the duct assembly 2 is maintained. The volume of the accumulators 8a . . . 8d may be increased to adapt the fuse assembly 1 to increased arc energy and/or reduced duct pressure. Controlled pressurisation of the ducts 4a . . . 4d may be used in the process of arc extinction.

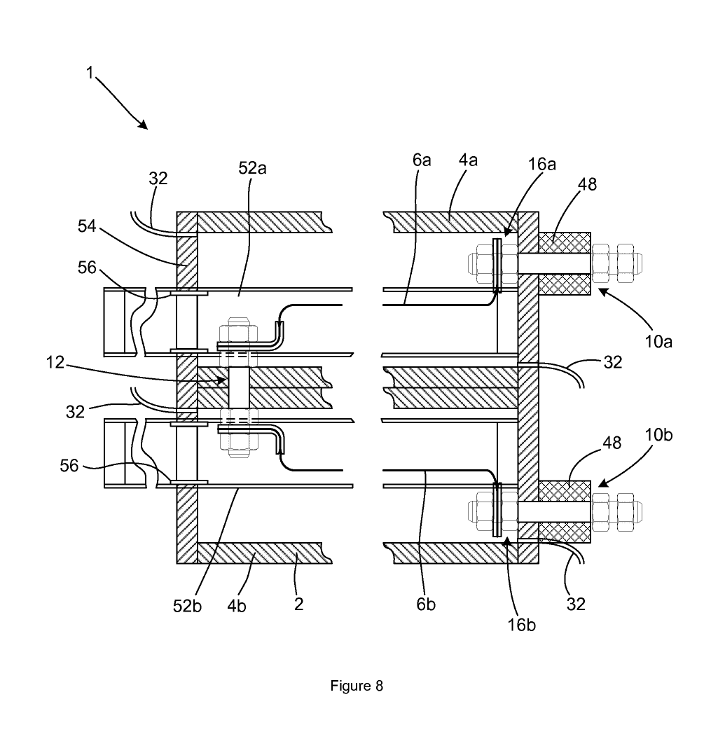

FIG. 8 shows an alternative arrangement where each accumulator 52a, 52b extends through the end plate 54 without terminal bushings. Whilst the diameter of the accumulators may be adjusted to control the internal pressure of the ducts 4a . . . 4d, there is a possibility that the diameter of the accumulators may be sufficiently large to exert an unreasonable influence on the cross section of the ducts, thereby increasing the overall size of the fuse assembly. The alternative arrangement uses a continuation of the accumulators 52a, 52b outside the space that is occupied by the ducts. Although the volume of the section of each accumulator 52a, 52b that is within the associated duct can do no more than collapse to an internal volume approaching zero, it is able to do so with an internal pressure that is dependent upon the volume of the section of each accumulator that is outside the associated duct. The section of each accumulator that is outside the duct may be sealed as shown or it may be vented to atmosphere or to any convenient chamber, thereby facilitating a degree of control over the peak pressure within the associated duct. As shown in FIG. 8, the accumulators 52a, 52b are sealed to the end plate 54 by inserting a rigid or compressible ferrule 56, thereby compressing the elastomeric wall of each accumulator between the bore of the respective hole in the end plate and the outside diameter or the ferrule. However, other methods of sealing, for example, threaded fittings, may be used and these may additionally be employed to permit any convenient form of external pipework to be connected to the end of each accumulator 52a, 52b. This connection to external pipework may additionally incorporate a flow restricting orifice of any convenient form. As in the case of the inlet and outlet pipes, segregated pipe runs may be employed.

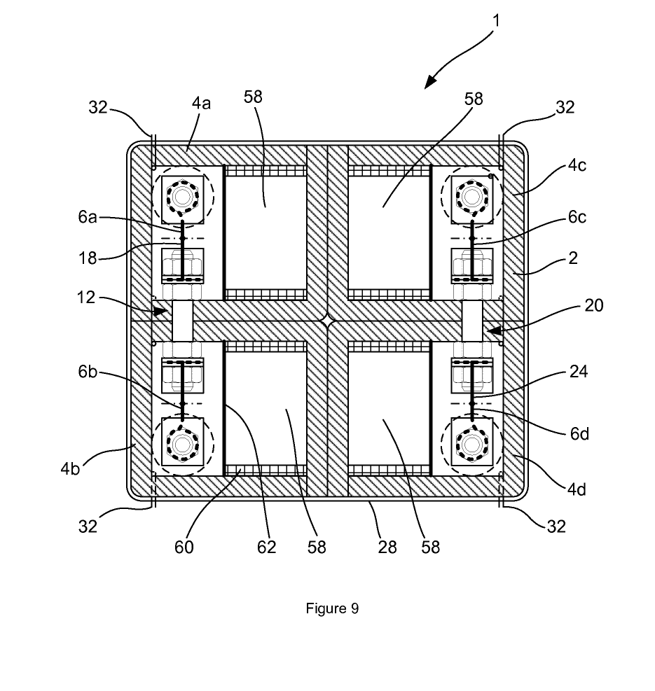

FIG. 9 shows another alternative arrangement in which each accumulator 58a, 58b, 58c, 58d is in the form of a substantially flat elastomeric sheet or diaphragm. Each accumulator 58a . . . 58d may assume a rectangular cross section as installed and may either be structurally self-contained, i.e. have four longitudinal and two end faces that are bonded or otherwise secured and sealed to one another, or may employ the associated duct walls as part of its structure. As shown in FIG. 9, a rectangular wall frame 60 is bonded to the duct wall and the flat elastomeric sheet 62 is then bonded to the wall frame. Any convenient method of construction can be employed. Ducts 4a . . . 4d having a rectangular cross section can be used to maximise the volume of the accumulator 58a . . . 58d with respect to the volume of the duct. This type of accumulator also maximises the deformable surface area of the accumulator that is in line of sight communication with the associated fusible conductor element 6a . . . 6d, whilst minimising that line of sight distance in a manner that moderates the effect of shock waves that radiate from the arc.

The various accumulators can be pressurised by any convenient method and it would be acceptable for the accumulators to be permanently deformed or damaged as a consequence of the operation of the fuse assembly. Aside from any arrangements in which the fusible conductor elements are wound around an associated accumulator, it will generally be the case that the physical separation between the accumulator material and the fusible conductor elements within the ducts will be sufficient to provide substantial thermal protection for the accumulator during arcing.

It will be readily appreciated that the fusible conductor elements and the accumulators are consumable components of such a fuse assembly 1 and, although such a fuse assembly may be intended to be repairable, it would not be expected to interrupt many faults in its operational lifetime.

The fuse assembly shown in FIGS. 1 and 2 with four fusible conductor elements 6a . . . 6d and ducts 4a . . . 4d having a rectangular cross section provides a convenient, cost-effective and practical arrangement. But other arrangements are possible. For example, the general principles described above can be applied to any even number of fusible conductor elements as long as the fusible conductor elements are connected together in series to define at least one fuse element and are orientated within the fuse assembly such that they experience a mutually repulsive force. The fusible conductor elements must extend substantially along the longitudinal axis of the fuse assembly. The fusible conductor elements must also be circumferentially spaced around the longitudinal axis of the fuse assembly, e.g. for four elements they are arranged at each apex of a square or rectangular array, for six elements that are arranged at each apex of a hexagonal array, and so on for any suitable polygonal array having the same number of sides as the total number of fusible conductor elements. In the case of a fuse assembly having six fusible conductor elements then they can all be connected together in series to define one fuse element (suitable for a unipolar HVDC supply) or three fusible conductor elements could be connected together to define a first substantially serpentine-shaped (or ‘folded’) fuse element and three fusible conductor elements could be connected together to define a second substantially serpentine-shaped fuse element. In this case, since each fuse element includes an odd number of fusible conductor elements (i.e. n=3) then asymmetric fault currents with a bipolar DC supply will not have the mutual repulsion force of the fault-affected fusible conductor elements, but it is a suitable assembly for unipolar DC supply and symmetric fault current situations. Unlike in the fuse assembly shown in FIGS. 1 and 2, the first and fourth external terminals would be located at one end of the fuse assembly and the second and third external terminals would be located at the other end of the fuse assembly.

The ducts are not limited to a rectangular cross section. For example, ducts having a circular cross section can be used. Such ducts can be inherently more tolerant of internal pressure and the external banding that is employed in the case of rectangular ducts is not essential and may optionally be omitted. A central space is present between the four ducts and in a derivative of the third fixing arrangement shown in FIG. 7 an electrically insulated support rod may be inserted through this space to compress the end plates on to the end faces of the circular ducts. Bleed holes can be located in both end plates in alignment with the top and bottom of the central space so as to allow the central space to fill with liquid dielectric. Vent pipes are not required on these particular bleed holes because the central space is not subjected to arcing and pressure. With circular cross section ducts the internal terminals can be recessed into flat seats formed in the duct walls or spacers that provide a flat seat and conform to the inner surface of the duct wall can be used. Such features would be designed to have minimal effect on the bursting strength of the circular ducts. Other duct cross sections can be used as required.

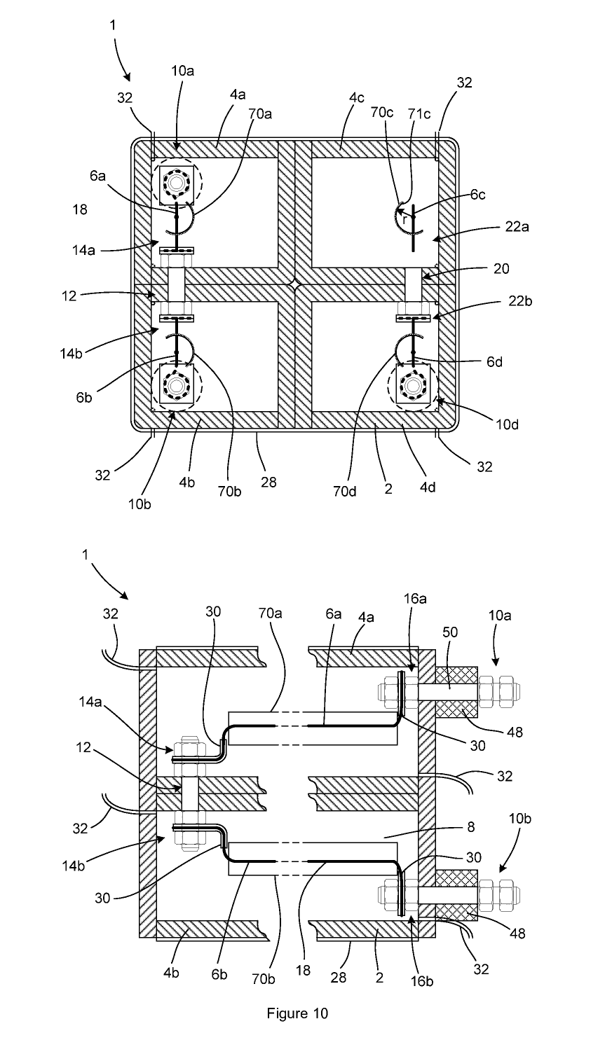

The fuse elements, strain reliefs and terminals may have optional electrostatic shields that are configured to suppress surface discharges and the potential formation of conductive streamers that can propagate and lead to breakdown between these components. One possible shield arrangement is shown in FIG. 10, but it will be readily appreciated that suitable shield elements can be used with any of the fuse assemblies described above. In FIG. 10, certain components of the fuse assembly (e.g. the accumulators) have been omitted to enable the electrostatic shields to be clearly seen. The components that are most susceptible to surface discharges are the substantially parallel runs of fusible conductor elements 6a . . . 6d whose cross sectional dimensions are substantially less than the respective spacings between fusible conductor elements within the fuse assembly. Accordingly, each fusible conductor element 6a . . . 6d is provided with a corresponding electrostatic shield 70a, 70b, 70c, 70d, which is formed from metallised polypropylene film. The metallisation 71a, 71b, 71c, 71d of the film is electrically connected to the terminals 10a, 10b, 10c, 10d, 12 and 20 at the corresponding ends of the fusible conductor elements by any convenient means. The shield metallisation is, therefore, connected electrically in parallel with the corresponding fusible conductor element.

The surface of each electrostatic shield 70a . . . 70d is formed to a radius r about the axis of the corresponding fusible conductor element 6a . . . 6d at its end terminations and this profile is substantially maintained along the length of the shield by being held in tension by suitably shaped terminations. As a result of its electrically parallel connection with a corresponding fusible conductor element, the metallised surface of each shield adopts an axial voltage distribution that is substantially equal to the voltage distribution along the corresponding fusible conductor element when the fuse assembly operates at currents below its rupturing capacity. The metallisation is sufficiently thin relative to its resistivity and cross sectional area as to carry a current that is a small proportion (typically less than 1%) of the current that flows in the corresponding fusible conductor element 6a . . . 6d. As such the fuse pre-arcing characteristic of the fuse assembly is dominated by that of the fusible conductor element 6a . . . 6d and the risk of premature rupturing or resistance instability in the metallisation is substantially eliminated. The metallisation and film composition can be the same as those employed in metallised polypropylene film capacitors. The radius r is chosen to minimise the electric field enhancement factor in the liquid dielectric between shields.

Following extended thermal overloads or the application of a low resistance fault at the load, the fusible conductor elements 6a . . . 6d will melt and rupture and arcs will be established along their length. During the melting and establishment of arcs, a corresponding increased voltage drop will be present between terminals at the ends of each fusible conductor element 6a . . . 6d, thereby causing the current in the shield metallisation to increase and for the metallisation to rupture. The shield is, therefore, a secondary fusible conductor element.

The collapsible accumulators of the fuse assembly are also exposed to a proportion of the voltage between fusible conductor elements (and shields when used) and may suffer internal discharge. Optionally, the elastomeric wall material of the accumulators may incorporate a non-linear resistive stress grading characteristic in order to suppress internal surface discharges. The accumulators may optionally be filled with a discharge suppressing gas, for example sulphur hexafluoride. The location of the accumulators may also be chosen so as to reduce their exposure to any electric field. The gas bubble that forms as a result of arcing may have its pressure moderated by a collapsible accumulator that is located in any convenient position within the insulation material ducts.

What is claimed is:

1. A fuse assembly, comprising:
2n fusible conductor elements, where n is an integer, wherein
the fusible conductor elements extend along, and are circumferentially spaced around, a longitudinal axis of the fuse assembly,
the fusible conductor elements are connected together in series to define a fuse element, and
the fusible conductor elements are orientated within the fuse assembly such that current flowing along each fusible conductor element is in the opposite direction to current flowing along the fusible conductor element or fusible conductor elements adjacent to it;
a supply terminal connected to an end of the fuse element and connectible to a DC supply; and
a load terminal connected to an opposite end of the fuse element and connectible to an electrical load.

2. A fuse assembly, comprising:
2n fusible conductor elements, where n is an integer, wherein:
the fusible conductor elements extend along, and are circumferentially spaced around, a longitudinal axis of the fuse assembly,
a first fuse element includes n fusible conductor elements connected together in series and a second fuse element includes n fusible conductor elements connected in series, and
the fusible conductor elements are orientated within the fuse assembly such that current flowing along each fusible conductor element is in the opposite direction to current flowing along the fusible conductor element or fusible conductor elements adjacent to it;
a first supply terminal connected to an end of the first fuse element and connectible to a DC supply;
a first load terminal connected to an opposite end of the first fuse element and connectible to an electrical load;
a second supply terminal connected to an end of the second fuse element and connectible to the dc supply; and
a second load terminal connected to an opposite end of the second fuse element and connectable to the electrical load.

3. The fuse assembly according to claim 1, wherein the fusible conductor elements are equally spaced around the longitudinal axis of the fuse assembly.

4. The fuse assembly according to claim 1, wherein the fusible conductor elements are circular wire elements or foil elements.

5. The fuse assembly according to claim 1, wherein the fusible conductor elements are straight and parallel with the longitudinal axis of the fuse assembly.

6. The fuse assembly according to claim 1, wherein the fusible conductor elements have a serpentine or helical form, the neutral axis of each fusible conductor element is parallel with the longitudinal axis of the fuse assembly.

7. The fuse assembly according to claim 1, further comprising four fusible conductor elements arranged in a square or rectangular array.

8. The fuse assembly according to claim 1, wherein the fuse assembly is immersed in liquid dielectric.

9. The fuse assembly according to claim 1, wherein each fusible conductor element is positioned within a respective duct.

10. The fuse assembly according to claim 9, wherein the ducts are filled with liquid dielectric.

11. The fuse assembly according to claim 9, further comprising a collapsible accumulator positioned within each duct.

12. The fuse assembly according to claim 8, further comprising at least one collapsible accumulator.

13. The fuse assembly according to claim 9, wherein the ends of the ducts are sealed by end plates.

14. The fuse assembly according to claim 13, wherein the end plates include small openings through which liquid dielectric can be supplied to, and removed from, the ducts.

15. The fuse assembly according to claim 1, wherein the fusible conductor elements are connected to the terminals by compression contacts that incorporate strain reliefs.

16. The fuse assembly according to claim 2, wherein the fusible conductor elements are equally spaced around the longitudinal axis of the fuse assembly.

17. The fuse assembly according to claim 2, wherein the fusible conductor elements are circular wire elements or foil elements.

18. The fuse assembly according to claim 2, wherein the fusible conductor elements are straight and parallel with the longitudinal axis of the fuse assembly.

19. The fuse assembly according to claim 2, wherein the fusible conductor elements have a serpentine or helical form, the neutral axis of each fusible conductor element is parallel with the longitudinal axis of the fuse assembly.

20. The fuse assembly according to claim 2, further comprising four fusible conductor elements arranged in a square or rectangular array.
